(19) United States
(12) Patent Application Publication
(10) Pub. No.: US 2009/0019082 A1
(43) Pub. Date: Jan. 15, 2009

(54) System and Method for Discovery of Common Information Model Object Managers

(75) Inventors: Drue A. Reeves, Round Rock, TX (US); Jon R. Hass, Austin, TX (US); Jimmy D. Pike, Georgetown, TX (US)

Correspondence Address: BAKER BOTTS, LLP, 910 LOUISIANA, HOUSTON, TX, 77002-4995, US

(73) Assignee: DELL PRODUCTS L.P.

(21) Appl. No.: 11/775,471

(22) Filed: Jul. 10, 2007

(51) Int. Cl. G06F 17/00

(52) U.S. Cl. 707/103 X; 707/103 R; 707/E17.055

(57) ABSTRACT

A system and method is disclosed for managing objects in accordance with the Common Information Model. A CIMOM installation utility identifies directory services that are coupled to or included within the network or computing environment. Once identified, the directory services are extended to include an additional managed object of the Common Information Model. After the schema of the directory service is extended, the managed object is created in at least one of the directory services. Following these steps, a client of the network is able to execute a discovery process to locate the directory services and managed objects of the directory services, thereby allowing the client to communicate with the managed objects of the directory services, including the managed object that was added as part of the extension of the schema of one or more of the directory services.

### TECHNICAL FIELD

The present disclosure relates generally to computer systems and information handling systems, and, more particularly, to a system and method for the discovery of Common Information Model Object Managers.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

The Distributed Management Task Force, Inc. (DMTF) is an organization involved in the development of management standards for computing systems. One DMTF standard is the Common Information Model (CIM). The Common Information Model provides a common definition of management information for systems, networks, applications, and services, while allowing for vendor extensions of the same. CIM's common definitions enable vendors to exchange management information between systems throughout the network. The CIM standard is composed of both a CIM specification and a CIM schema. The CIM schema provides the data model for each managed object of the system. Objects identify and describe the resources of the system. Standard CIM schema covers many of the standard elements of a computer system.

A computing system that supports the CIM will include a CIM object manager (CIMOM), which provides an interface between CIM providers and management applications. A CIM provider retrieves data and event notifications from the managed objects of the system. In an enterprise computing environment, the discovery of CIM object managers is often accomplished through the Service Location Protocol (SLP). Like many multi-cast protocols, the SLP is often filtered at a switch in the network, thereby preventing some clients located at certain points in the enterprise network from seeing or discovering each CIM object manager. Although SLP also involves the use of directory agents for aggregating SLP communications, the use of a directory agent creates a single point of failure in the discovery process for CIM object managers. If the directory agent is down, for example, CIM object managers cannot be discovered. In addition, during the period that a directory agent is not operational, the associated database of directory information used by the directory agent is likewise not available for use by the nonoperational directory agent or other components of the computing system.

### SUMMARY

In accordance with the present disclosure, a system and method is disclosed for managing objects in accordance with the Common Information Model. A CIMOM installation utility identifies directory services that are coupled to or included within the network or computing environment. Once identified, the directory services are extended to include an additional managed object of the Common Information Model. After the schema of the directory service is extended, the managed object is created in at least one of the directory services. Following these steps, a client of the network is able to execute a discovery process to locate the directory services and managed objects of the directory services, thereby allowing the client to communicate with the managed objects of the directory services, including the managed object that was added as part of the extension of the schema of one or more of the directory services.

The system and method disclosed herein provides a technical advantage in that the schema of the directory service can be extended in a manner that provides a sufficient description of and a location for the managed CIM objection of the network. Because of the descriptive properties of the schema, the managed object can be uniquely located and discovered in the network. The disclosed system is also technically advantageous in that the clients of the system are able, through the use of a set of known commands, to discover objects that have been added to the directory services. The system and method disclosed herein is also advantageous in that the existing directory service of the network can serve as a data structure for the addition of managed objects to the network or computing environment. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of the CIM components of a computing environment;

FIG. 2 is a diagram of a directory service; and

FIG. 3 is a flow diagram of a series of method steps for populating a directory service with a managed object and discovering that managed object at a client node.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

The system and method disclosed herein involves the use of a directory service as the directory agent for the discovery of CIM object managers in an enterprise computing environment. Because the directory service is replicated and distributed across the enterprise computing environment, the directory service is widely available and does not constitute a single point of failure within the computing environment. To implement client security, the directory service includes built-in access control lists. Because the directory service is extensible, additional CIM object managers may be defined to the directory service.

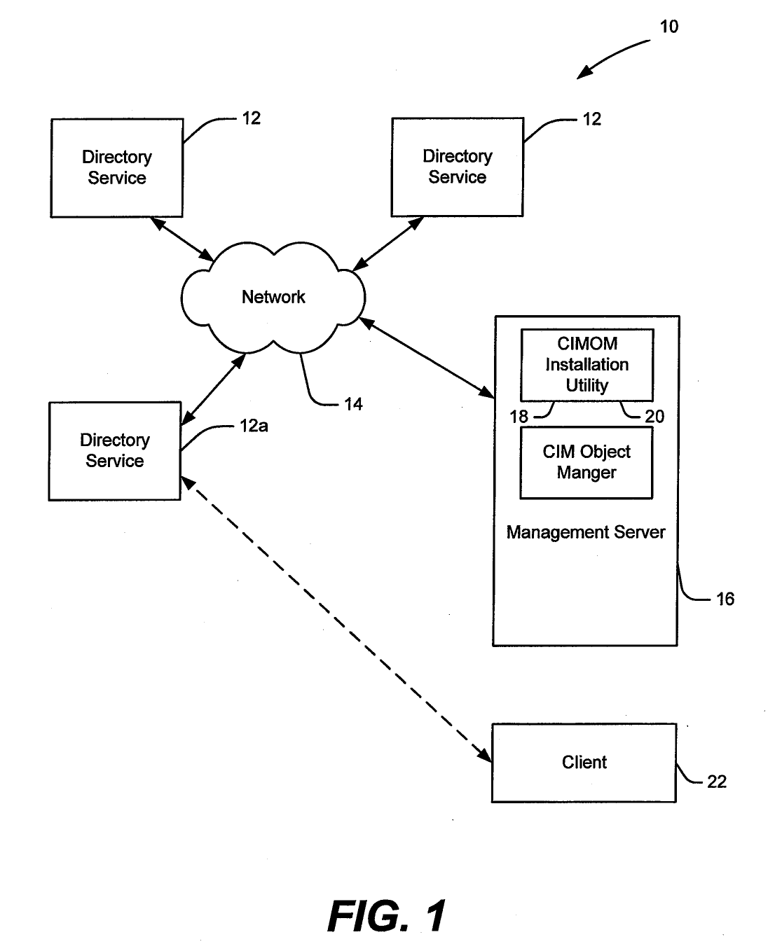

Shown in FIG. 1 is a diagram of the CIM components of a computing environment, which is indicated generally at 10. The computing environment 10 includes a network 14. Included within the network 14 are multiple directory services, which are each indicated at 12. Also coupled to network 14 is a management server 16, which includes a CIMOM installation utility 18 and a CIM object manager 20. In the example of FIG. 1, a client node 22 of the computing environment is coupled to one of the directory services, which is designated in this example as 12a. In operation, the CIMOM Installation Utility 18 issues a query to identify the directory services 12 within the network. Once the directory services have been identified by the CIMOM Installation Utility, the administrator of the management server has a choice of directory services on which it can install a CIM object.

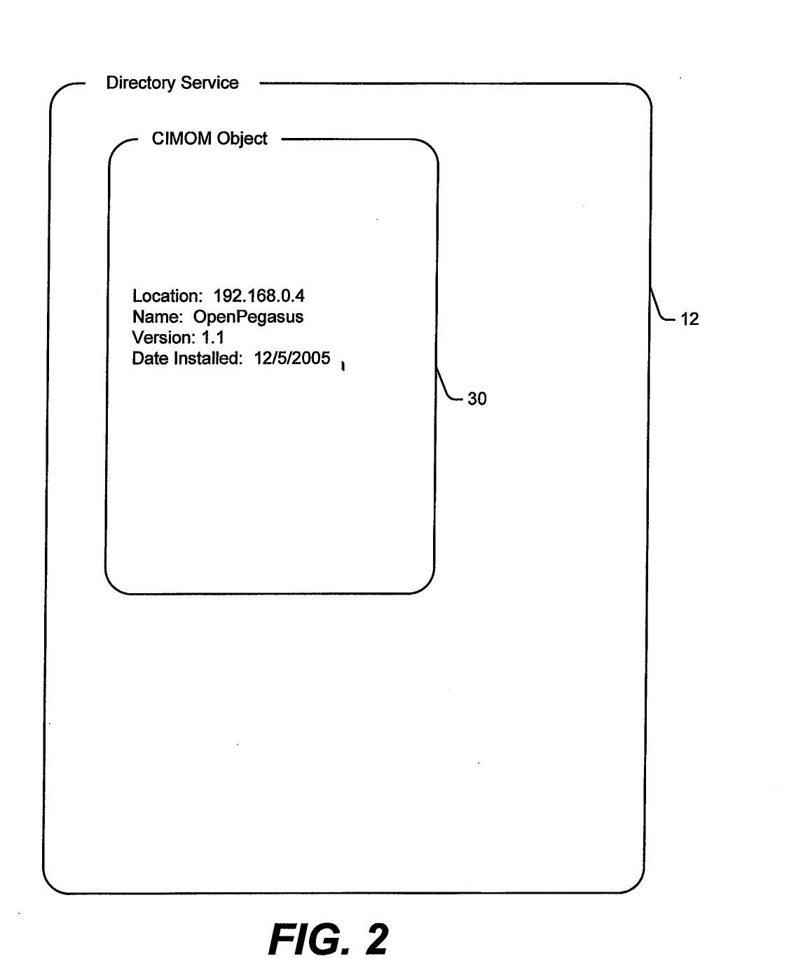

Following the identification of the directory services 12 in the network, one of the directory services of the network is selected and the CIMOM installation utility 18 performs a routine to extend the schema of the directory service to include a CIM object with a set of identifying and operational parameters, including CIMOM name, IP address or location, version, date of installation, and other parameters. Following the extension of the schema in the selected directory service, the CIM object manager 20 is initiated on management server 16, causing the CIM object manager to populate the empty fields of the directory service to describe the CIM object that is to be managed by the CIM object manager. Shown in FIG. 2 is a diagram of a directory service 12, which includes a defined CIM object 30. As indicated in FIG. 2, the CIM object is defined as by the CIMOM name, IP address, version, and date of installation. As an alternative to the steps set out above, the administrator of the management server could use a directory service management tool to extend the schema of a directory service. Following the extension of the directory schema, the administrator could use the directory service management tool to create the CIMOM object and populate the fields of the extended directory with information concerning the CIM object to be managed.

Following the creation of the CIM object in the directory service, a client 22 of the network will access the directory service of the CIM object using its own set of access credentials. The client's use of its own access credentials is an access policy that insures that only those users with rights to the object can view and access the object in the directory service. In addition, however, it is possible for other access schemes to be employed, including schemes that allow unlimited or anonymous access to a managed object by any client of the network. After accessing the directory service 12a, client 22 queries the directory service 12a to identify CIM objects of the directory service. In this manner, client 22 is able to conduct a discovery process in which the client 22 discovers the CIM objects of the network. The client is thus able to select a CIM object to be managed and would direct management commands to the discovered CIM object.

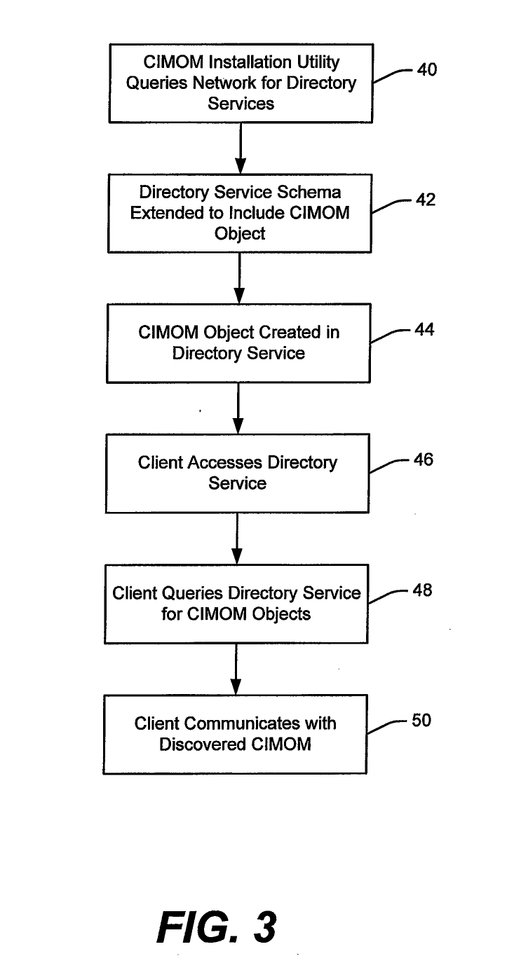

An example of the steps of the method set out herein is shown in FIG. 3. At step 40, the CIMOM installation utility queries the network for directory services. Following the identification of the directory services, a directory service is selected and the schema of the directory service is extended at step 42 to include the CIM object. Following the extension of the directory service at step 42, a CIM object is created in the directory service at step 44. At step 46, a client accesses the selected directory service, and, at step 48, the client is able to query the directory service for CIM objects. At step 50, the client is able to communicate with the discovered CIM objects, including the recently created CIM object.

Although the system and method has been described herein with reference to the CIM system management protocol, it should be understood that the system and method described herein may be employed with other system management protocols. Although the present disclosure has been described in detail, it should be understood that various changes, substitutions, and alterations can be made hereto without departing from the spirit and the scope of the invention as defined by the appended claims.

What is claimed is:

1. A system for managing objects in a computing environment, comprising:
multiple directory services, wherein each of the directory services is able to include a schema for the identification of a managed object of the computing environment;
an installation utility communicatively coupled to the directory services and able to identify the directory services in the computing environment and extend the schema of a directory service to include an additional managed object; and
an object management utility communicatively coupled to the directory services in the computing environment and operable to populate a managed object added to a directory service by the installation utility.

2. The system for managing objects in an enterprise computing environment of claim 1, wherein the installation utility and the object management utility are included within a management server of the computing environment.

3. The system for managing objects in an enterprise computing environment of claim 1, further comprising a client node communicatively coupled to the computing environment and operable to discover an object that was populated by the object management utility.

4. The system for managing objects in an enterprise computing environment of claim 1, further comprising a client node communicatively coupled to the computing environment and operable to discover an object of the directory service that was populated by the object management utility.

5. The system for managing objects in an enterprise computing environment of claim 1, further comprising a client node communicatively coupled to the computing environment and operable to discover all objects of the directory service, including the object that was most recently populated by the object management utility.

6. The system for managing objects in an enterprise computing environment of claim 1, wherein the client node is communicatively coupled to at least one of the directory services of the computing environment.

7. The system for managing objects in an enterprise computing environment of claim 1,
wherein the installation utility and the object management utility are included within a management server of the computing environment; and
a client node communicatively coupled to the computing environment and operable to discover an object that was populated by the object management utility.

8. The system for managing objects in an enterprise computing environment of claim 1,
wherein the installation utility and the object management utility are included within a management server of the computing environment; and
a client node communicatively coupled to the computing environment and operable to discover an object of the directory service that was populated by the object management utility.

9. The system for managing objects in an enterprise computing environment of claim 1,
wherein the installation utility and the object management utility are included within a management server of the computing environment; and
a client node communicatively coupled to the computing environment and operable to discover all objects of the directory service, including the object that was most recently populated by the object management utility.

10. The system for managing objects in an enterprise computing environment of claim 1,
wherein the installation utility and the object management utility are included within a management server of the computing environment; and
wherein the client node is communicatively coupled to at least one of the directory services of the computing environment.

11. A method for managing objects in a computing environment, comprising:
identifying directory services in the computing environment;
extending the schema of at least one directory service to include an object;
creating a managed object in the extended directory service;

12. The method for managing objects in a computing environment of claim 11, wherein the managed object is a managed object of the Common Information Model.

13. The method for managing objects in a computing environment of claim 11, wherein the step of extending the schema of at least one directory service to include an object comprises the step of extending the schema of each directory service of the computing environment.

14. The method for managing objects in a computing environment of claim 11, further comprising the step of executing a discovery process to identify the managed object that was added to the directory service having the extended schema.

15. The method for managing objects in a computing environment of claim 11, wherein the step of identifying the directory services in the computing environment is performed by a central server able to communicate with each of the directory services of the computing environment.

16. The method for managing objects in a computing environment of claim 11, wherein the step of extending the schema includes the step of extending the schema to include an object of the Common Information Model.

17. The method for managing objects in a computing environment of claim 11,
wherein the step of extending the schema includes the step of extending the schema to include an object of the Common Information Model; and
further comprising the step of executing a discovery process to identify the managed object that was added to the directory service having the extended schema.

18. A system for managing CIM objects in a computing environment, comprising:
directory services, wherein each of the directory services is able to include a schema for the identification of a managed CIM object;
an installation utility communicatively coupled to the directory services and able to identify the directory services in the computing environment and extend the schema of a directory service to include an additional CIM object; and
an object management utility communicatively coupled to the directory services in the computing environment and operable to populate a managed CIM object added to a directory service by the installation utility.

19. The system for managing CIM objects in a computing environment of claim 18, further comprising a client node communicatively coupled to the computing environment and operable to discover an object that was populated by the object management utility.

20. The system for managing CIM objects in a computing environment of claim 18, wherein the installation utility and the object management utility are included within a management server of the computing environment.
